(19) United States
(12) Patent Application Publication
(10) Pub. No.: US 2018/0247620 A1
(43) Pub. Date: Aug. 30, 2018

(54) CURVED CAJON

(71) Applicant: CHAN MUSICAL CO., LTD., Bangkok (TH)

(72) Inventor: Krisakorn Chandontrikij, Bangkok (TH)

(21) Appl. No.: 15/441,541

(22) Filed: Feb. 24, 2017

(51) Int. Cl. G10D 13/02

(52) U.S. Cl. CPC G10D 13/02

(57) ABSTRACT

A cajon is provided including a body including a plurality of panels coupled together to define an interior resonant chamber. One of the plurality of panels is curved. At least one opening formed in said plurality of panels is configured to emit noise from said body when a force is applied to said body.

### BACKGROUND

This disclosure relates generally to percussion instruments, and more particularly, to cajon drums or cajones.

The cajon is a generally six panel, rectangular box shaped percussion instrument, originating from Peru. The instrument is typically played by slapping one or more surfaces thereof with hands, fingers, feet, or sometimes various devices, such as mallets or sticks for example. In some instances, layers of identical thickness are used on all six panels of the cajon, resulting in poor acoustic projection. In other implementations, pieces having a substantially identical thickness are used for five panels of the box, and a thinner sheet of plywood is used on the sixth panel. In such instances, the panel formed from the thinner plywood acts as the striking surface.

### SUMMARY

According to an embodiment, a cajon is provided including a body including a plurality of panels coupled together to define an interior resonant chamber. One of the plurality of panels is curved. At least one opening formed in said plurality of panels is configured to emit noise from said body when a force is applied to said body.

In addition to one or more of the features described above, or as an alternative, in further embodiments a cross-section of said body is substantially uniform over a height of said cajon.

In addition to one or more of the features described above, or as an alternative, in further embodiments a curvature of said curved panel extending in one plane.

In addition to one or more of the features described above, or as an alternative, in further embodiments a curvature of said curved panel extending in more than one plan

In addition to one or more of the features described above, or as an alternative, in further embodiments a curvature of said curved panel is non-uniform about an axis.

In addition to one or more of the features described above, or as an alternative, in further embodiments a curvature of said curved panel is generally uniform about an axis.

In addition to one or more of the features described above, or as an alternative, in further embodiments said curvature is substantially semi-circular.

In addition to one or more of the features described above, or as an alternative, in further embodiments said curvature exceeds 180 degrees of the periphery of a circle.

In addition to one or more of the features described above, or as an alternative, in further embodiments said plurality of panels includes a front panel, a left panel extending from a first edge of said front panel, a right panel extending from a second edge of said front panel, and a back panel coupling said left panel and said right panel.

In addition to one or more of the features described above, or as an alternative, in further embodiments said back panel is said curved panel, and said back panel, said left panel, and said right panel are integrally formed.

In addition to one or more of the features described above, or as an alternative, in further embodiments a diameter of said back panel is greater than a width of said front panel.

In addition to one or more of the features described above, or as an alternative, in further embodiments a thickness of said front panel is less than a thickness of said left panel, said right panel, and said back panel.

In addition to one or more of the features described above, or as an alternative, in further embodiments one or more instruments are arranged within said resonant interior chamber and are operably coupled to said front panel.

### BRIEF DESCRIPTION OF THE DRAWINGS

The subject matter, which is regarded as the present disclosure, is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a perspective view of a percussion instrument according to an embodiment;

FIG. 2 is a cross-sectional view of the percussion instrument of FIG. 1 according to an embodiment; and

FIG. 3 is a front view of the percussion instrument of FIG. 1 according to an embodiment.

The detailed description explains embodiments of the present disclosure, together with advantages and features, by way of example with reference to the drawings.

### DETAILED DESCRIPTION

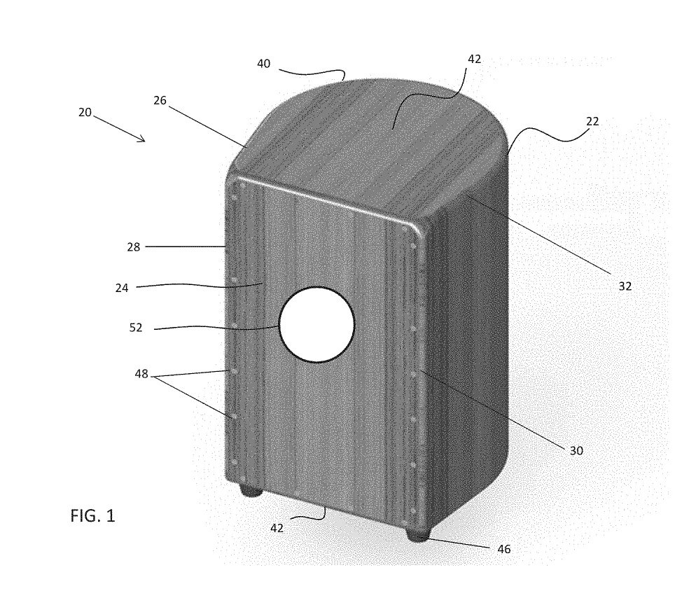

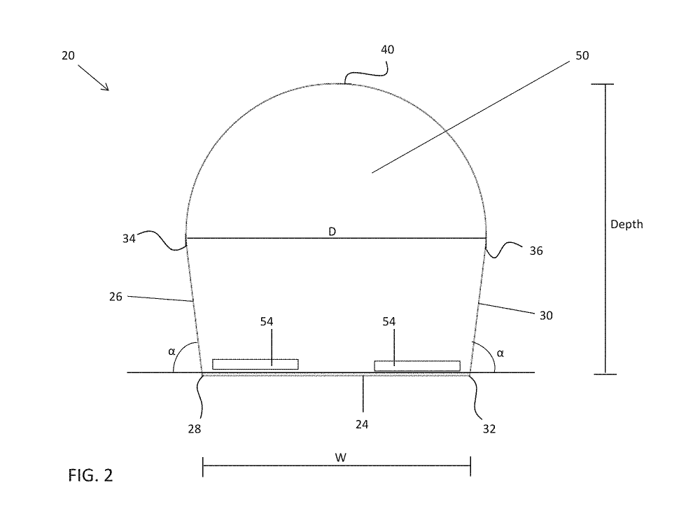

With reference to FIGS. 1-3, various views of a percussion instrument 20, specifically a cajon, are illustrated. The cajon 20 includes a frame or body 22 having a plurality of panels. The frame 22 includes a generally rectangular front panel 24 arranged within a vertical plane. A left panel 26 extends from a first edge 28 of the front panel 24 and a right panel 30 extends from a second, opposite edge 32 of the front panel 24. In the illustrated, non-limiting embodiment, each of the left panel 26 and the right panel 30 are generally rectangular in shape and also extend within a vertical plane. Both the left panel 26 and the right panel 30 extend from the front panel 24 in the same direction and have a substantially same, but oppositely oriented angle a (see FIG. 2). However, embodiments having different angles a are also contemplated herein. In an embodiment, both the left and right panel 26, 30 extend at an angle generally outward from the front panel 24 such that a distance between the distal ends 34, 36 of the left panel 26 and the right panel 30 is greater than a width W of the front panel 24. However, embodiments where one or both of the left panel 26 and right panel 28 are angled generally inwardly, towards one another, are also within the scope of the disclosure.

A curved back panel 40 extends between and couples the distal ends 34, 36 of the left panel 26 and the right panel 30. In embodiments where the left and right panel 26, 30 are angled outwardly relative to the front panel 24, the diameter D of the curvature of the back panel 40 is greater than the width W of the front panel 24. The curvature of the back panel 40 may be substantially uniform in shape, similar to a circle, or alternatively, may vary, similar to an oval. In embodiments where the curvature is uniform, the curvature may be substantially semi-circular, or may include greater than 180 degrees of the periphery of a circle, such as between 180 degrees and 270 degrees for example. Although the back panel 40 illustrated and described herein is curved in a single plane, embodiments where the back panel 40 includes a curvature extending in more than one plane are also contemplated herein.

As best shown in FIG. 1, the curved back panel 40 may be integrally formed with one or both of the left panel 26 and the right panel 30. In such embodiments, the left and right panel 26, 30 extend from the ends of the radius of curvature. However, embodiments where one or more of the left panel 26, back panel 40, and right panel 30 are formed separately are also within the scope of the disclosure.

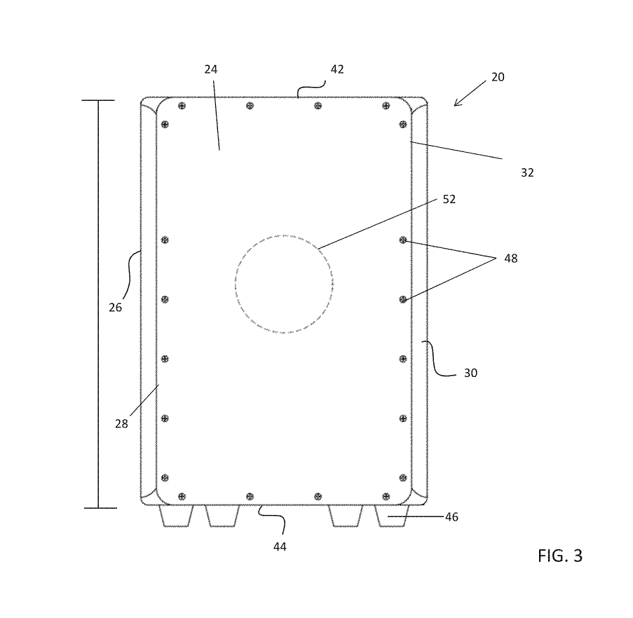

As suggested, each of the front panel 24, left panel 26, back panel 40, and right panel 30, extend vertically. In the illustrated, non-limiting embodiment, best shown in FIG. 1, the contours of the front, left, back, and right panels 24, 26, 40, 30, remain generally constant over the vertical height of the cajon. However, embodiments where a one or more of the front panel 24, left panel 26, back panel 40, and right panel 30 has a non-planar configuration are also contemplated herein. Further, as shown, the vertical height H (FIG. 3) of the cajon 20 is generally greater than the width W or depth of the cajon 20. However, embodiments where at least one of the width and depth is greater than or equal to the height of the cajon 20 are also within the scope of the disclosure.

An upper panel 42 is arranged at a first end of the each of the front panel 24, left panel 26, back panel 40, and right panel 30, and a lower panel 44 is similarly positioned at a second, opposite end of each of the front panel 24, left panel 26, back panel 40, and right panel 30. The upper panel 42 and the lower panel 44 are generally parallel to one another and arranged within a horizontal plane. One or more feet 46, such as formed from a rubber material for example, may extend from the lower panel to support the cajon 20 in an upright orientation.

The plurality of panels 24, 26, 30, 40, 42, and 44 may be attached to one another using fasteners 48, such as screws or nails for example, to form the body 22. When connected, the plurality of panels 24, 26, 30, 40, 42, and 44 define a generally hollow interior resonant chamber 50. In an embodiment, the interface between adjacent panels of the body 22 may be rounded or smoothed.

At least one of the plurality of panels 24, 26, 30, 40, 42, and 44 of the cajon 20 is designated as a striking surface, commonly referred to as the tapa. In the illustrated, non-limiting embodiment, the front panel 24 is intended as the striking surface. Accordingly, each of the left panel 26, back panel 40, right panel 30, and upper and lower panels 42, 44 may be constructed using a piece of wood having a thickness between about 0.5 inches and about 0.75 inches. The striking surface, i.e. front panel 24 of the cajon 20, may be formed from a piece of wood having a comparatively reduced thickness, such as between about 0.1 inches and about 0.5 inches. However, it should be understood that in other embodiments any of the plurality of panels 24, 26, 30, 40, 42, and 44 of the cajon 20 may be selected as the striking surface and as a result will have a corresponding reduced thickness. In embodiments where the cajon 20 has multiple striking surfaces, the thickness of the striking surface panels may be the same or different.

At least one opening 52 is typically formed in one or more of the panels 24, 26, 30, 40, 42 44 of the cajon 20, such as the front panel 24 for example. The openings 52 are intended to allow sound generated by application of a force to the instrument to emit from the resonant chamber 50.

Due to the thinness of the strike surface panel, in the illustrated, non-limiting embodiment panel 24, the strike surface panel is configured to vibrate when struck. To generate a variety of noises from the cajon 20, one or more metal strings, snares or other suitable instruments, illustrated schematically at 54, may be arranged within the resonant chamber 50 and coupled to one or more strike surfaces of the cajon 20. Accordingly, by striking the strike surface in different places, a user can thus produce a variety of different percussive sounds.

While the present disclosure has been particularly shown and described with reference to the exemplary embodiments as illustrated in the drawing, it will be recognized by those skilled in the art that various modifications may be made without departing from the spirit and scope of the present disclosure. Therefore, it is intended that the present disclosure not be limited to the particular embodiment(s) disclosed as, but that the disclosure will include all embodiments falling within the scope of the appended claims.

1. A cajon comprising:
a body including a plurality of panels coupled together to define an interior resonant chamber, wherein a first panel of said plurality of panels is curved and a second panel of said plurality of panels is generally rectangular in shape; and
at least one opening formed in said second panel of said plurality of panels to emit noise from said body when a force is applied to said body.

2. The cajon according to claim 1, wherein a cross-section of said body is substantially uniform over a height of said cajon.

3. The cajon according to claim 1, wherein a curvature of said curved panel extending in one plane.

4. The cajon according to claim 1, wherein a curvature of said curved panel extending in more than one plane.

5. The cajon according to claim 1, wherein a curvature of said curved panel is non-uniform about an axis.

6. The cajon according to claim 1, wherein a curvature of said curved panel is generally uniform about an axis.

7. (canceled)

8. The cajon according to claim 6, wherein said curvature is substantially semi-circular.

9. The cajon according to claim 6, wherein said curvature exceeds 180 degrees of the periphery of a circle.

10. The cajon according to claim 1, wherein said plurality of panels includes
a front panel, a left panel extending from a first edge of said front panel, a right panel extending from a second edge of said front panel, and a back panel coupling said left panel and said right panel.

11. The cajon according to claim 10, wherein said back panel is said curved panel, and said back panel, said left panel, and said right panel are integrally formed.

12. The cajon according to claim 10, wherein a diameter of said back panel is greater than a width of said front panel.

13. The cajon according to claim 10, wherein a thickness of said front panel is less than a thickness of said left panel, said right panel, and said back panel.

14. The cajon according to claim 10, wherein one or more instruments are arranged within said resonant interior chamber and are operably coupled to said front panel.
